(19) United States
(12) Patent Application Publication
(10) Pub. No.: US 2003/0081404 A1
(43) Pub. Date: May 1, 2003

(54) Portable apparatus employing luminous disk

(76) Inventors: Shaw-Jong Wang, Hsinchu Hsien (TW); Chih-Ping Liang, Hsinchu Hsien (TW)

Correspondence Address: Harold V. Stotland, Seyfarth Shaw, 42nd Floor, 55 East Monroe Street, Chicago, IL, 60603-5803, US

(21) Appl. No.: 10/315,605

(22) Filed: Dec. 10, 2002

Related U.S. Application Data
(63) Continuation-in-part of application No. 09/905,009, filed on Jul. 13, 2001, now Pat. No. 6,513,951.

(30) Foreign Application Priority Data
Dec. 31, 2001 (TW) 090224482

(51) Int. Cl. F21V 33/00; F21V 9/16

(52) U.S. Cl. 362/84; 362/253; 362/806

(57) ABSTRACT

A portable apparatus disclosed hereinafter comprises a luminous disk and a bracing portion. The luminous disk includes a disk lamination having a substrate and a metallic reflecting layer formed on a surface of the substrate; and a light emitting lamination superposed on the surface of the metallic reflecting layer opposite to the surface of the substrate for emitting light when it receives an external electrical power. The light emitting lamination includes an electroluminescence section, which luminesces in case the external electrical power is supplied thereon, and a biasing section for receiving and applying the external electrical power onto the electroluminescence section. The bracing portion includes a bracing part, a stretching part extended from the bracing part, and a contact part, which combines the luminous disk and the bracing apparatus together, and conducts the electrical power to the luminous disk.

### CROSS-REFERENCE TO RELATED APPLICATIONS

The application is a continuation-in-part of application Ser. No. 09/905,009, filed on Jul. 13, 2001, and the disclosure of which is incorporated herein by reference.

### BACKGROUND OF THE INVENTION

1. Field of the Invention

The present invention relates to a portable apparatus employing luminous disk, in particular, to an apparatus employing an optical disk having one surface thereof capable of storing digital data while the other surface capable of emitting light.

2. Description of Related Art

Optical disks have been extensively serving as a recording medium for storing digital data of video, audio and software programs. One side of the optical disk is the readable surface, containing data read out by laser, and the other side marked with predetermined pictures and letters is the label surface for indicating the subject, content or actor relevant to the digital data. Therefore, the label surface with colorful pattern can decorate the appearance of the optical disk.

However, optical disk is always dedicated to the major and monotonous role as a recording medium for general users. U.S. Pat. No. 6,280,809 by a primary inventor named Shaw-Jong Wang, also the inventor of the present invention, entitled “luminous disk,” discloses an optical disk comprising a disk lamination and a light emitting lamination. The disk lamination has at least a substrate and a metallic reflecting layer on which digital data is recorded, and the light emitting lamination can vividly illuminate when a external electrical power is supplied. In short, the disk lamination acts as either a compact disk (CD) or digital versatile disk (DVD), and the light emitting lamination can be considered a light source.

U.S. Pat. No. 6,280,809, filed Mar. 14, 2001, also by Shaw-Jong Wang, entitled “lamp having a readable disk with an electro-luminescent element,” discloses a lamp including a luminous disk and a socket. The luminous disk in U.S. Pat. No. 6,280,809 is as the same as that in U.S. Pat. No. 6,280,809, and the socket has plugs for receiving external electrical power and a body for allowing the luminous disk to be inserted therein and to be switched on as the light emitting function.

The aforementioned lamp, utilizing a luminous disk, can only be placed at specific indoor space and this matter makes it lack portability. Therefore, how to increase the application value of the illuminating apparatus is the spirit of the invention.

### SUMMARY OF THE INVENTION

The object of the present invention is to provide a portable apparatus employing luminous disk so as to increase the value of the optical disk and thus to have a multi-functional lamp.

The second object of the present invention is to provide a portable apparatus comprising a luminous disk with a DIY surface so that users can design their favorite appearance of the disk.

The third object of the present invention is to provide a flexible illuminating apparatus without the limitation of illuminating angles.

The forth object of the present invention is to provide a portable apparatus having a bracing portion, which enables the apparatus to be held by users, to be put on a table as a decoration, to be used as a reading light in cars, or to be worn as a necklace.

The fifth object of the present invention is to provide a portable apparatus with a highly additive value achieved by the variations of the luminous disk, such as a variety of shapes and colors, and the creation of users themselves, so that a personal product is thus created.

To achieve the objects above, the portable apparatus in accordance with the present invention comprises a luminous disk and a bracing portion. The luminous disk includes a disk lamination having a substrate and a metallic reflecting layer formed on a surface of the substrate; and a light emitting lamination superposed on the surface of the metallic reflecting layer opposite to the side of the substrate for emitting light when it receives an external electrical power. The light emitting lamination includes an electroluminescence section having a first plane and an opposite second plane, which luminesces in case the external electrical power is supplied on the first and the second planes; and a biasing section having a first electrode layer on the first plane of the electroluminescence section and a second electrode layer between the electroluminescence section and the metallic reflecting layer for receiving and applying the external electrical power onto the first and the second planes of the electroluminescence section. The bracing portion includes a bracing part, a stretching part extended from the bracing part, and a contact part, which combines the luminous disk and the bracing part together and conducts an electrical power signal to the luminous disk.

A favorable embodiment of the luminous disk is characterized in that the luminous disk is provided with a light-transmission sticker for sticking on the blank surface of the light emitting lamination, thus the product can be more user friendly and easy to access.

In accordance with another aspect of the present invention, the device is provided with a shapable mechanism, such as a wire or a plastic member that can be bent and then fix in the shape the user made. With the shapable mechanism, the device can be shaped into any configuration the user wants. Besides, due to the bendable character, the mechanism is somehow deemed as having a changeable length, thus the apparatus can be extensively used as a distant illuminating apparatus.

By the construction described above, the optical disk is endowed with a better application or preservation values due to its light emitting function. For example, the optical disk can serve as a luminous article when it is not played, be held by participants in a concert in replacement of the existing luminous stick, be displaced on a table as a decoration, be used as a reading lighting in a car, or be worn as a necklace.

Moreover, the light emitting lamination can also be properly modified so as to be in a particular shape, on partial surface of the disk, or in different colors. Furthermore, the optical disk can also periodically emit light in cooperation with a proper driving device. Therefore, the disk according to this invention will provide an essential element for various applications and thus increase the value of the disk.

### BRIEF DESCRIPTION OF THE DRAWINGS

The present invention is described below by way of examples with reference to the accompanying drawings which will let readers understand more easily the purpose, technical contents, characteristics and achievement of the present invention, wherein

FIG. 1 depicts a portable apparatus of a first embodiment of the present invention;

FIG. 2 is an exemplary light-transmission sticker sheet provided in the present invention;

FIG. 3 is an enlarged partial section view of the luminous disk according to the first embodiment of the present invention;

FIG. 4 is an enlarged partial section view of the luminous disk according to a second embodiment of the present invention;

FIG. 5 is an enlarged partial section view of the luminous disk according to a third embodiment of the present invention;

FIG. 6 is an enlarged partial section view of the luminous disk according to a fourth embodiment of the present invention;

FIG. 7(a) is a backside view of the portable apparatus according to the first embodiment device of the present invention;

FIG. 7(b) depicts a front view of the portable apparatus according to the first embodiment device of the present invention;

FIGS. 8(a) and 8(b) are operational diagrams of the bracing portion and the contact portion of the first embodiment of the present invention;

FIG. 9 is an exploded diagram of the bracing portion of the present invention;

FIGS. 10(a) and 10(b) depict a second embodiment of a portable apparatus of this invention;

FIG. 10(c) depicts a portable apparatus of the present invention used as a necklace;

FIGS. 11(a) and 11(b) depict a third embodiment of a portable apparatus of the present invention;

FIG. 12(a) depicts a fourth embodiment of a portable apparatus device of the present invention;

FIG. 12(b) illustrates a portable apparatus of the fourth embodiment of the present invention used as a reading light in a car;

FIGS. 13(a) and 13(b) is an exploded diagram of a fifth embodiment of a portable apparatus device of the present invention;

FIGS. 14(a) and 14(b) are exploded diagrams of a sixth embodiment of a portable apparatus of the present invention;

FIGS. 15(a) and 15(b) are exploded diagrams of a seventh embodiment of a portable apparatus of the present invention;

FIGS. 16(a) and 16(b) are exploded diagrams of an eighth embodiment of a portable apparatus of the present invention;

FIGS. 17(a) and 17(b) are exploded diagrams of a ninth embodiment of a portable apparatus of the present invention;

FIGS. 18(a) and 18(b) are exploded diagrams of a tenth embodiment of a portable apparatus of the present invention; and

FIG. 19 depicts a modified third embodiment of a portable apparatus of the present invention.

### DETAILED DESCRIPTION OF THE INVENTION

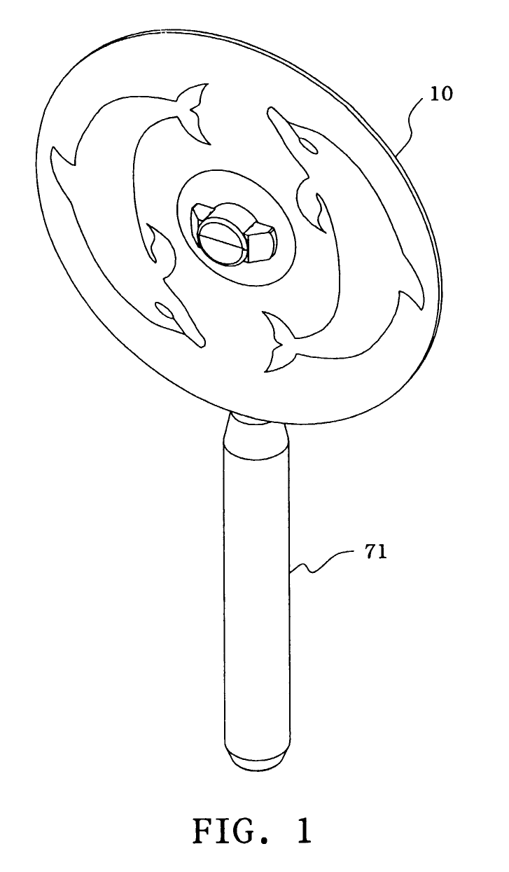

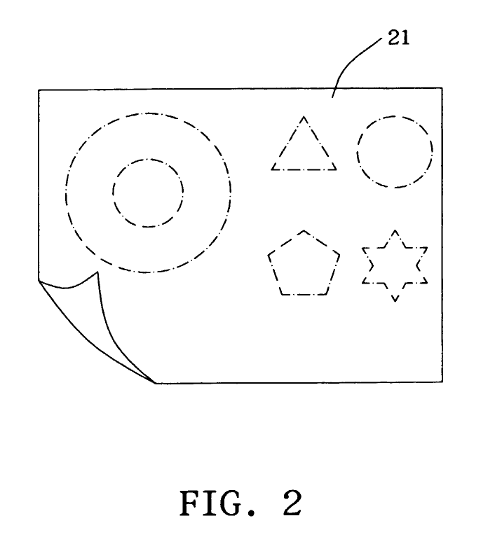

FIG. 1 depicts a first embodiment of a portable apparatus of the present invention. The portable apparatus comprises a luminous disk 10 which could be a shaped disk and a bracing portion 71. Users can design patterns on the surface of the luminous disk 10 at their will, such as the dolphins' pattern in this embodiment, with a disk pattern generation device and then print them on a provided light-transmission sticker sheet 21 with predetermined shapes on it, as shown in FIG. 2, by using a picture output device, such as a regular printer. The printed pattern is then detached from the sticker sheet 21 and stuck on the luminous side of the luminous disk. By this procedure, a personal and unique portable device is formed. The disk pattern generation device can be a personal computer and a printer, or any pattern output device.

FIG. 3 is an enlarged partial section view of the luminous disk according to the first embodiment of the present invention. It should be noticed that the scales of the components in the drawing are not identical with the true scales in the life-size product. The luminous disk 10 disclosed in this embodiment comprises a disk lamination 11 and a light emitting lamination 13, which are combined together by adhesive. A hole 12 is formed in the center of the disk 10 to be clamped for playing. The disk lamination 11 comprises a flat substrate 113, and a metallic reflecting layer 111 formed on the top of the substrate 113. The substrate 113 is generally made of a transparent plastic material. A pattern which represents digital data can be formed on the substrate 113 for storing digital data. Under this conformation, the disk lamination 11 serves as a CD-ROM, CD-R, CD-RW, DVD-ROM, DVD-R, DVD-RW, MD, etc. The light emitting lamination 13 comprises an electroluminescence section and a biasing section. The electroluminescence section comprises a dielectric layer 134 and a fluorescent layer 135, the upper surface and the bottom surface of the electroluminescence section are able to receive an external electrical power signal applied via the biasing section. The biasing section comprises a distribution layer 132, a bottom electrode layer 133 located between the bottom surface of the electroluminescence section and the distribution layer 132, and a transparent electrode layer 136 located above the upper surface of the electroluminescence section. The light emitting lamination 13 in FIG. 3 further comprises a bottom protection layer 131 located below the distribution layer 132 and an upper protection layer 137 located above the transparent electrode layer 136. Each of the distribution layer 132 and the transparent electrode layer 136 has an exposed area on its upper surface for forming a first conductive terminal 151 and a second conductive terminal 152.

The upper and lower protection layers 131 and 137 are used for protecting the light emitting lamination and can be constructed by any proper transparent protective material, such as polymer hardened by ultraviolet. The distribution layer 132 is a metallic layer formed by electroplating or any other proper method. An exposed area on the upper surface of the distribution layer 132 and adjacent to the hole 12 is formed for forming the second conductive terminal 152 as an interface to the external electrical power signal. The part of the upper surface of the distribution layer 132 other than the exposed area contacts with the bottom electrode layer 133, a metallic layer formed by printing or sputtering, for transmitting the electrical power signal received from the second conductive terminal 152 to the bottom electrode layer 133, and the bottom electrode layer 133 then further transmits the signal to the bottom surface of the electroluminescence section. The transparent electrode layer 136, disposed above the electroluminescence section, is a light-transmission layer made of indium tin oxide (ITO) or indium zinc oxide (IZO) by printing or sputtering. The transparent electrode layer 136 has an exposed area that stretched vertically to cover the other layers of the light emitting lamination 13 at the side of hole 12 for forming the first conductive terminal 151 as an interface to the external electrical signal. It is preferable to have a vertical insulating layer (not labeled) to isolate the first conductive terminal 151 from the other layers of the light emitting lamination 13.

By means of the bottom electrode layer 133 and the transparent electrode layer 136, the external electrical signal received by the first and the second conductive terminals 151 and 152 can be applied to the upper and the bottom surfaces of the electroluminescence section.

The fluorescent layer 135 luminesces when it is biased by an electrical signal. It may be made of any proper fluorescence material or electroluminescence material, no matter whether the material itself is organic or inorganic, by painting or sputtering according to the material used. The dielectric layer 134 of the electroluminescence section serves as an insulation layer in case the electroluminescence section is made of inorganic material.

According to the aforementioned structure, the electroluminescence section will luminesce when an external electrical signal is applied thereon via the first and the second conductive terminals 151 and 152, the distribution layer 132, the bottom electrode layer 133, and the transparent electrode layer 136. Moreover, the luminous disk 10 itself can store digital data by means of its disk lamination 11 and thus can also be taken as a data storage medium. Furthermore, when the disk lamination 11 of the luminous disk 10 is being played, the light emitting lamination 13 can be biased simultaneously by an external electrical signal and can thus emit light.

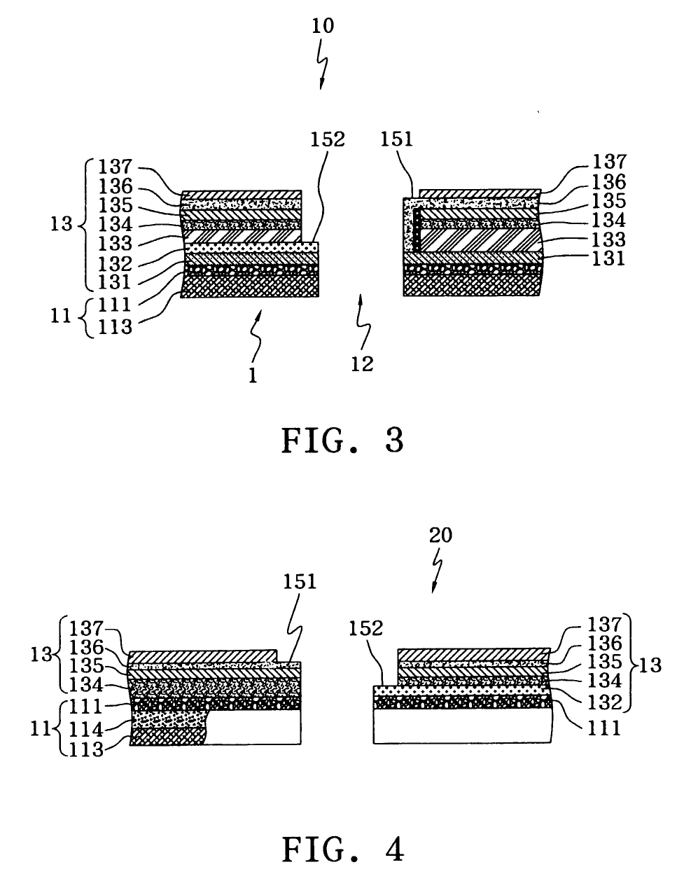

FIG. 4 is an enlarged partial section view of the disk according to the second embodiment of the present invention. As shown in FIG. 4, the luminous disk 20 comprises a disk lamination 11 and a light emitting lamination 13. The disk lamination 11 comprises a substrate 113, a metallic reflecting layer 111, and a dye layer 114 superposed between the substrate 113 and the metallic reflecting layer 111 for forming a pattern representative of encoded digital data under illumination of a laser beam. In this case, the pattern corresponding to the digital data to be stored will be burned onto the dye layer 114 by a laser beam after the luminous disk 20 is finished. In other words, the disk lamination 11 serves as a CD-R. The light emitting lamination 13 includes an electroluminescence section and a biasing section. The electroluminescence section of the light emitting lamination 13 of the luminous disk 20 consists of a fluorescence layer 135 and a dielectric layer 134. The biasing section of the light emitting lamination 13 of the luminous disk 20 comprises a distribution layer 132 and a transparent electrode layer 136 located above the upper surface of the electroluminescence section. The light emitting lamination 13 in FIG. 4 further comprises an upper protection layer 137 located above the transparent electrode layer 136.

In the structure shown in FIG. 4, the metallic reflecting layer 111 of the disk lamination 11 serves not only as a reflecting layer but also as a biasing electrode of the fluorescence layer 135, thus the bottom electrode layer 133 and the bottom protection layer 131 in the structure of FIG. 3 are omitted. Moreover, the transparent electrode layer 136 has an exposed area on its upper surface adjacent to the hole 12 for forming a first conductive terminal 151 as an interface to the external electrical signal, while a second conductive terminal 152 is formed by an exposed part of the distribution layer 132.

According to the aforementioned structure, when an external electrical signal is applied thereon to the first and the second conductive terminals 151 and 152, it will be delivered through the distribution layer 132, the metallic reflecting layer 111, and the transparent electrode layer 136. Then the transparent electrode layer 136 and the metallic reflecting layer 111 transfer the external electrical signal to the upper surface and the bottom surface of the electroluminescence section, thus it will luminesce.

FIG. 5 is an enlarged partial section view of the luminous disk according to the third embodiment of the present invention. The luminous disk 30 comprises a disk lamination 11 and a light emitting lamination 13. The light emitting lamination 13 further comprises a biasing section and an electroluminescence section. However, the distribution layer 132 and the dielectric layer 134 in the structure of the luminous disk 10 are removed. Thus, the light emitting lamination comprises a bottom protection layer 131, a bottom electrode layer 133, a fluorescence layer 135, a transparent electrode layer 136, and a top protection layer 137. This structure is especially for a light emitting lamination whose electroluminescence section is made of organic electroluminescence material.

The first conductive terminal 151 is formed as a circle surrounding the central hole 32 on the upper surface of the transparent electrode layer 136 without being covered by the top protection layer 137. The second conductive terminal 152 is formed also as a circle surrounding the central hole 32 on the upper surface of the bottom electrode layer 133 without being covered by any other layer.

According to the structure of the luminous disk 30, when an external electrical signal is applied thereon to the first and the second conductive terminals 151 and 152, it would be delivered by the transparent electrode layer 136 and the bottom electrode layer 133, and then the transparent electrode layer 136 and the bottom electrode layer 133 further transfer the external electrical signal to the upper surface and the bottom surface of the electroluminescence section, thus make it luminesce.

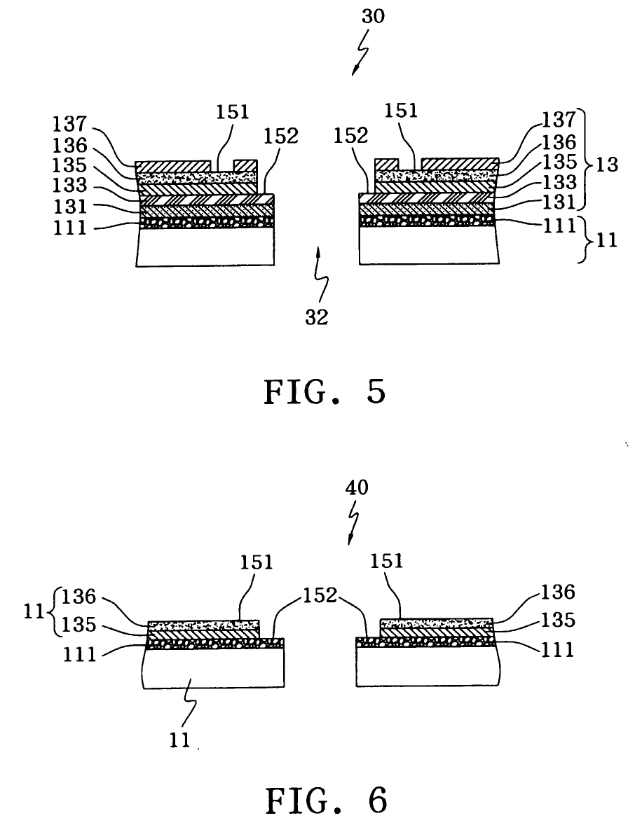

FIG. 6 is an enlarged partial section view of the luminous disk according to the fourth embodiment of the present invention. As shown in FIG. 6, the luminous disk 4 also comprises a disk laminatioin 11 and a light emitting lamination 13. The difference between the structure of the luminous disk 30 and the present structure lies in that the structure of the luminous disk 40 does not contain a bottom protection layer 131, a bottom electrode layer 133, and a top protection layer 137; this structure is the simplest one of the luminous disk in the present invention and is good for the light emitting lamination whose electroluminescence section is made of organic electroluminescence material. As in the structure of the luminous disk 30, a first and a second conductive terminal is formed as a circle surrounding the central hole of the disk. The first conductive terminal 151 is formed on the upper surface of the transparent electrode layer 136, and the second conductive terminal 152 is an exposed area formed directly on the metallic reflecting layer 111 which is taken as a bottom electrode here.

In this simplest structure of the luminous disk 40, when an external electrical signal is applied thereon to the first and the second conductive terminals 151 and 152, it will be delivered by the transparent electrode layer 136 and the metallic reflecting layer 133 to the upper surface and the bottom surface of the fluorescence layer 135 and make it luminesce.

The first and the second conductive terminals 151 and 152 could be placed on the surface of the disk lamination 11 or on the surface of the light emitting lamination 13 by through holes. The central portion of the luminous disk 4 could serve as a positioning mechanism for combining to an external portable apparatus.

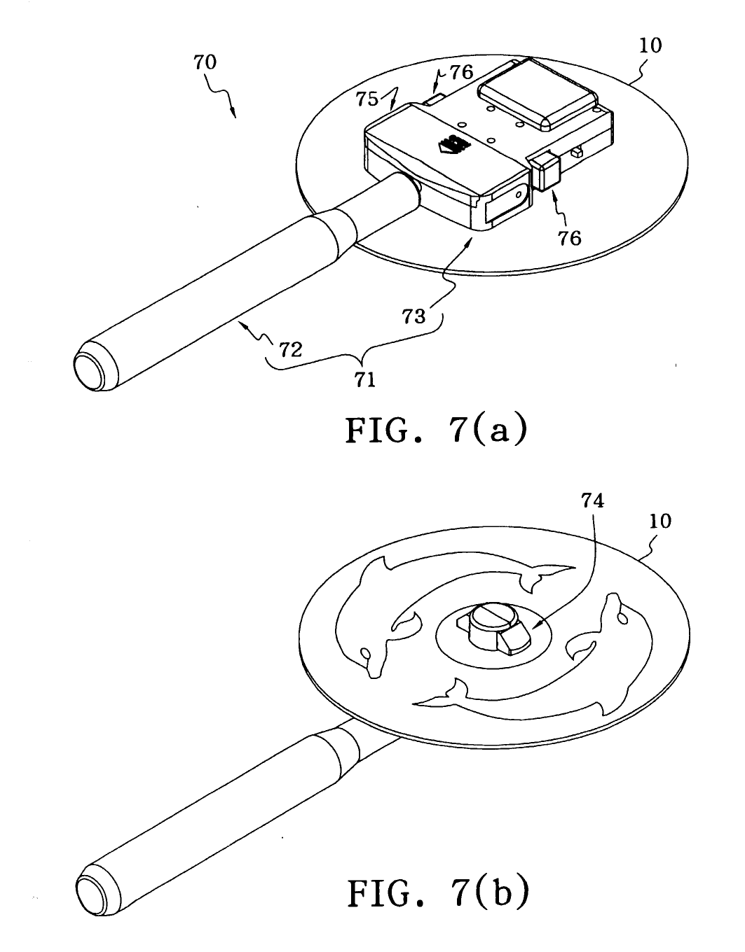

FIGS. 7(a) and 7(b) are the backside view and the front view of the portable apparatus of the first embodiment of the present invention, respectively. The device 70 comprises a bracing portion 71 and a luminous disk 10. The bracing portion 71 includes a bracing part 73, a stretching part 72, and a contact part 74. The bracing part 73 contains a battery container which can accommodate at least one battery as a power supply of the luminous disk 70; the stretching part 72 extends from the bracing part 73 and is designed so as to be held by users; the contact part 74 in the present embodiment is a pair of separable metallic pieces, its function is to combine the luminous disk 70 and the bracing portion 71 together, and conduct the battery power to the plural of conductive terminals of the luminous disk.

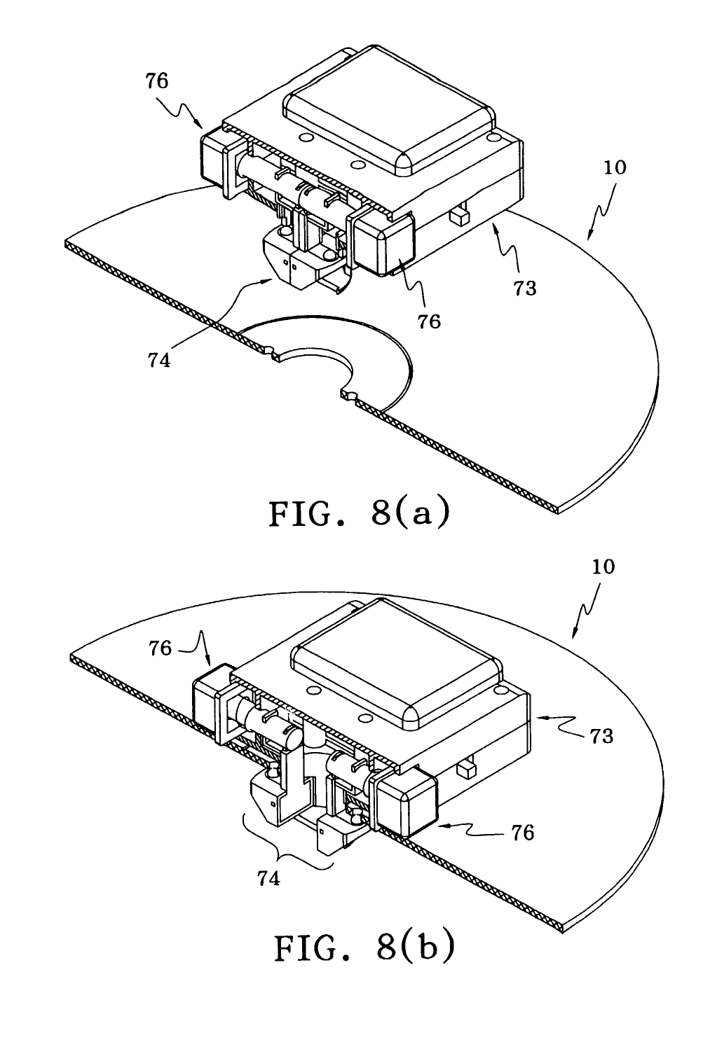

FIGS. 8(a) and 8(b) are operational diagrams of the bracing portion and the contact portion of the first embodiment of the present invention. As shown in FIG. 8(a), when two buttons 76 each of which possesses spring thereon located at the opposing side positions of the bracing part 73 are pressed, the two springs have the metallic pieces of the contact portion 74 drawn close to each other and thus become able to pass through the central hole of the luminous disk 10. After user passes the contact part 74 through the central hole of the luminous disk 10 and lets go the bottoms 76, the contact part 74 recovers to the original separate state as shown in FIG. 8(b), thus the combination of the bracing portion 71 and the luminous disk 10 of the present invention is done. Moreover, because the metallic pieces of the contact part 74 tightly contact with the plurality of conductive terminals of the luminous disk 10 when they recover to the original separate state, thus the power can be conducted to the luminous disk 10.

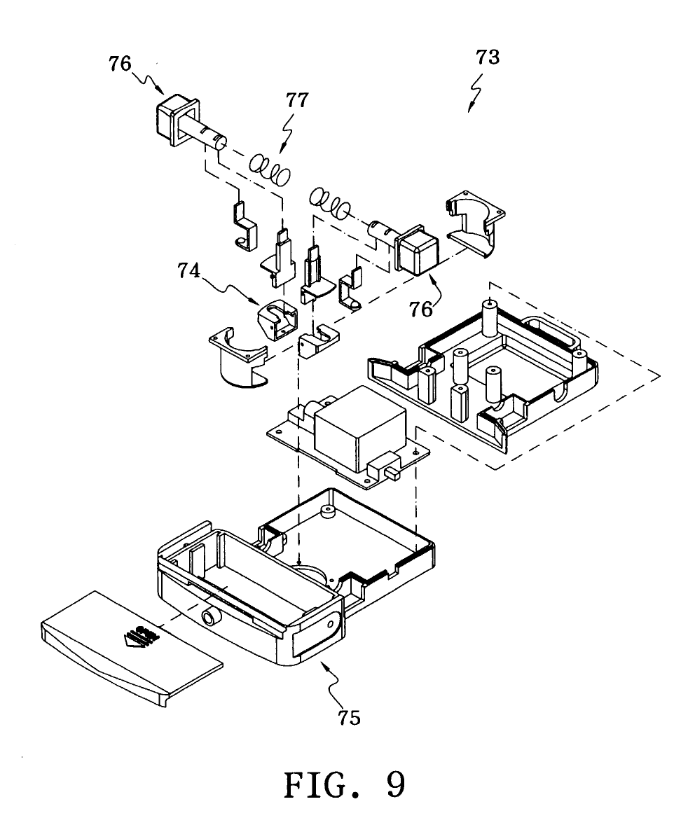

FIG. 9 is an exploded diagram of the bracing part 73 of the present invention. The buttons 76 control the movement of the contact portion 74 by elasticity of the springs 77. The battery container 75 can house at least one battery as the power supply of the luminous disk 10 of the present invention. The operation voltage of the present invention is between 60V to 150V, and the operation frequency is between 100 Hz to 5 KHz. Moreover, the power supply further connects to an inverter for transforming DC power to AC power, so it can provides a stable voltage and frequency to control luminescent variation of the electroluminescence layer of the luminous disk.

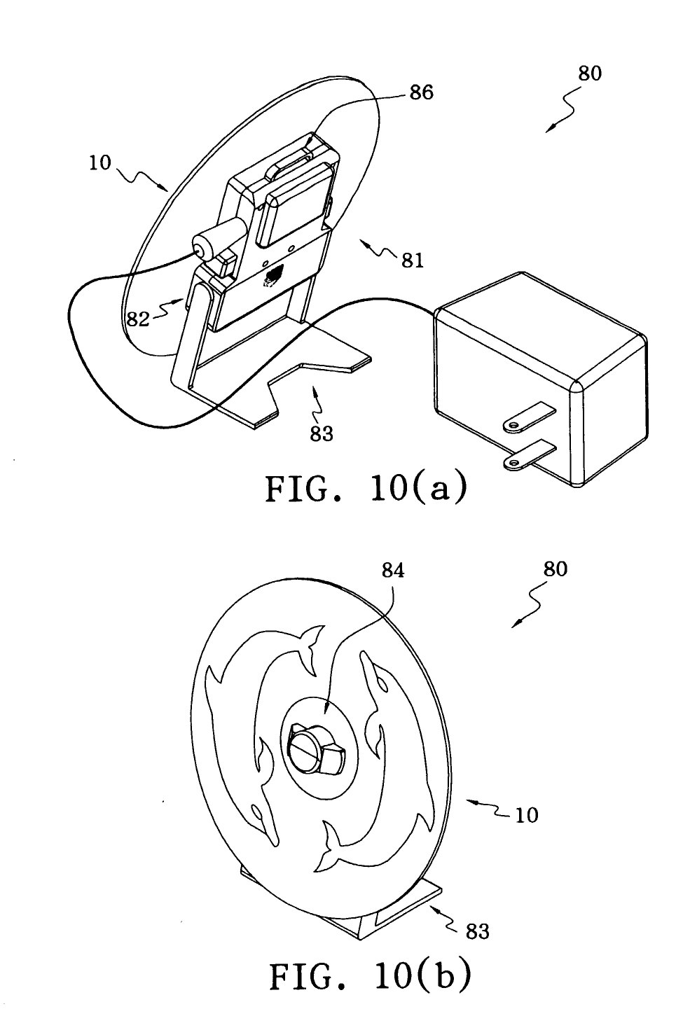

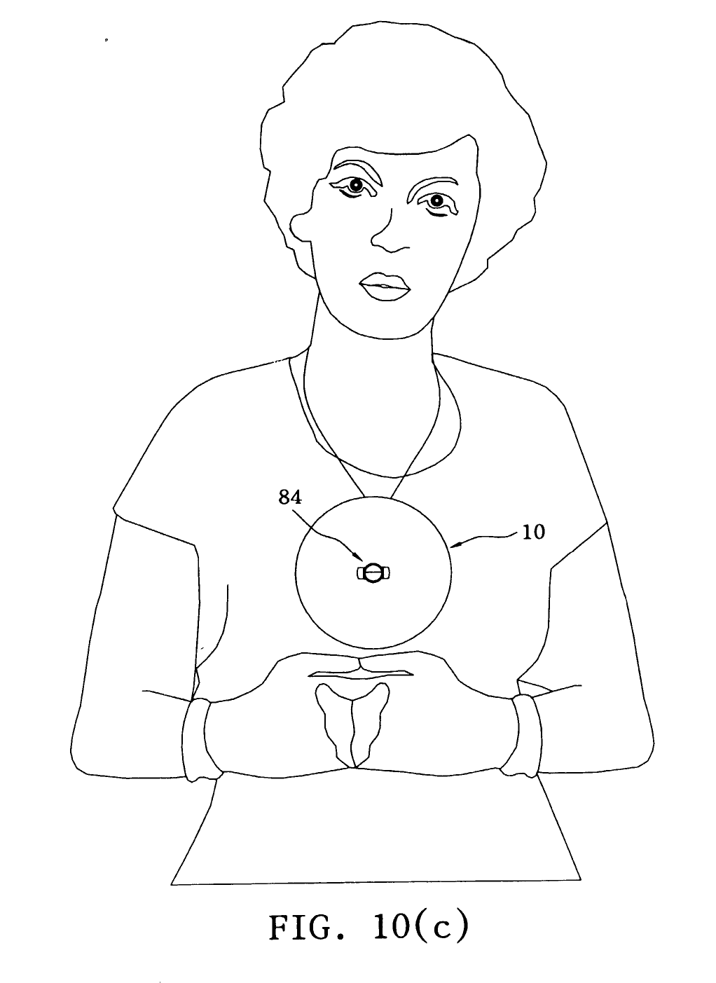

FIGS. 10(a) and 10(b) depict a second embodiment of a portable apparatus of the present invention. The bracing portion 81 of the present embodiment is in an upright formation, which comprises a bracing part 82, a contact part 84, and a base frame 83. The combination of the bracing portion 81 and the luminous disk 10 can be used as an ornament on a table. The portable apparatus 80 does not use battery power; instead, it uses ordinary outlet as the power supply, and thus needs a rectifier for transforming DC power from the outlet to a particular AC voltage and current to replace the battery power.

Moreover, an aperture 86 provided on top of the bracing part 82 so that a string can be passed through, and the portable apparatus becomes a necklace as shown in FIG. 10(c). Combined with the design on the surface of the luminous disk, the device can yet be regarded as a unique and stylish personal ornament.

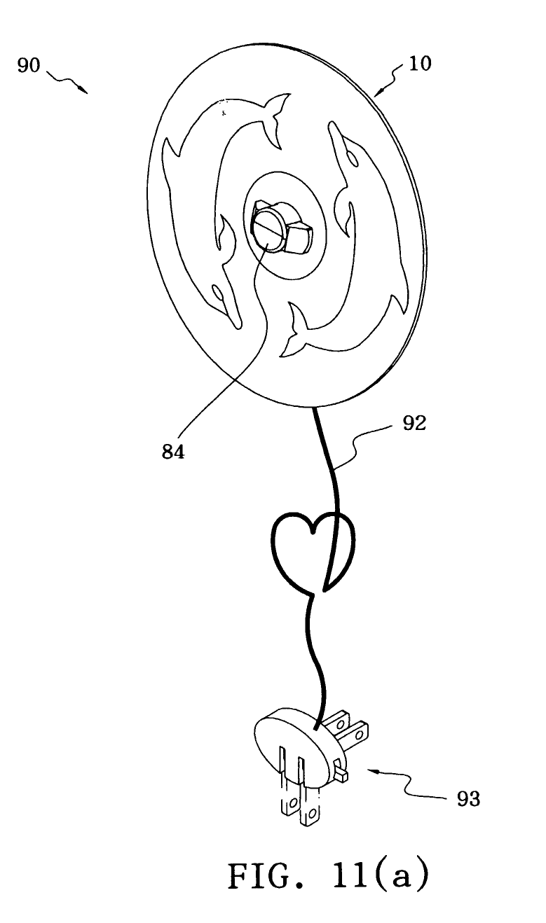

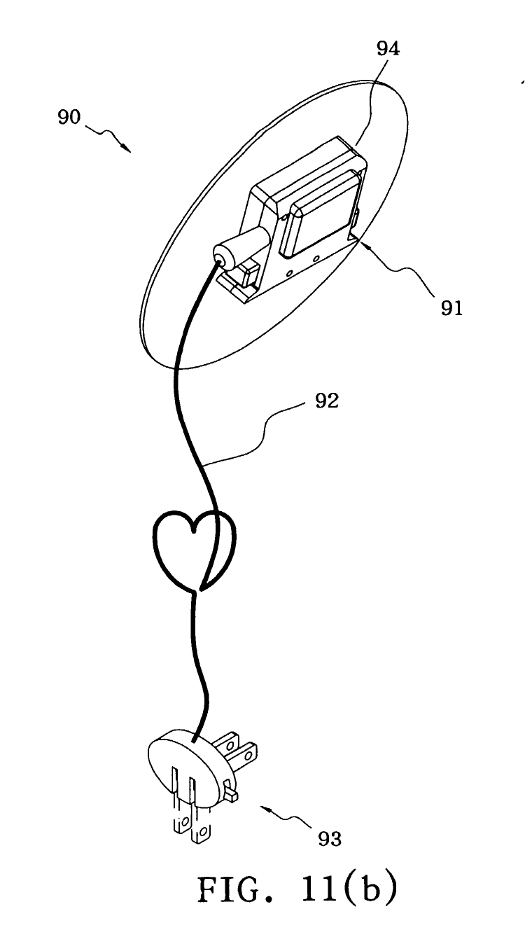

FIGS. 11(a) and 11(b) depict a front view and a back view of a third embodiment of a portable apparatus of the present invention, respectively. The portable apparatus 90 of the present embodiment comprises a luminous disk 10, a bracing portion 91, a shapable mechanism 92 connected to the luminous disk 10, and a plug 93. The bracing portion 91 includes a bracing part 94 and a contact part 95 for holding the luminous disk 10. The shapable mechanism 92, which is connected one end to the bracing portion 94 and the other end to the plug 93, allows users to create and bend any shape they like, and is made of shapable electrical wire with plastic shelter. Moreover, with the shapable mechanism 92, the portable apparatus 90 can serve as a distant illuminating apparatus if the shapable mechanism 92 is totally stretched out in a straight mode, this fact enables users to use the portable apparatus 90 as a changeable lighting and decorating apparatus, and if necessary, stretching out for a distant use.

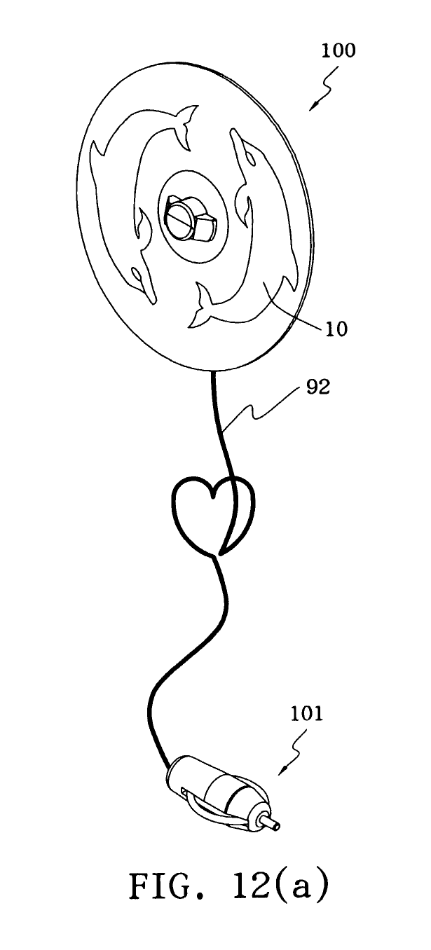

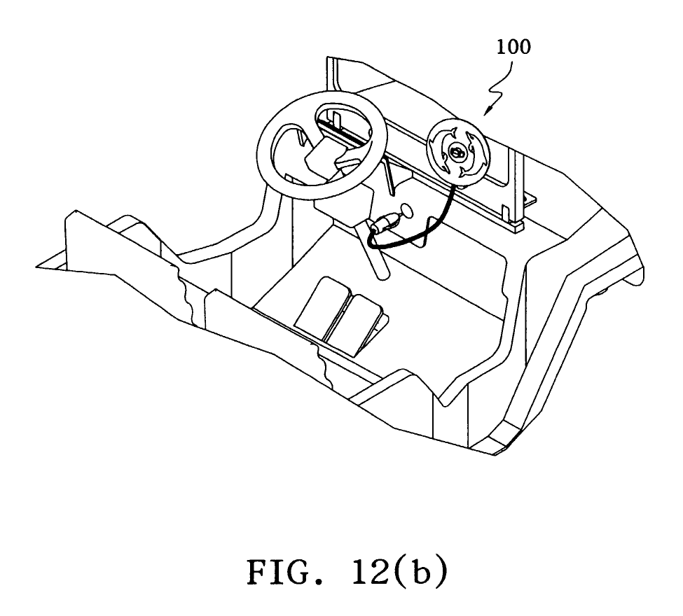

FIG. 12(a) depicts a fourth embodiment of a portable apparatus of the present invention. The portable apparatus 100 of the present embodiment is the same with the one in the third embodiment except for the plug part. The plug 101 in the present embodiment is modified so as to fit into the socket in a car, as shown in FIG. 12(b). The design makes the passenger at the passenger seat, or even at the back seat able to read at nighttime without turning on the dome light, and thus prevents the lightening dome light from interfering the vision of the driver.

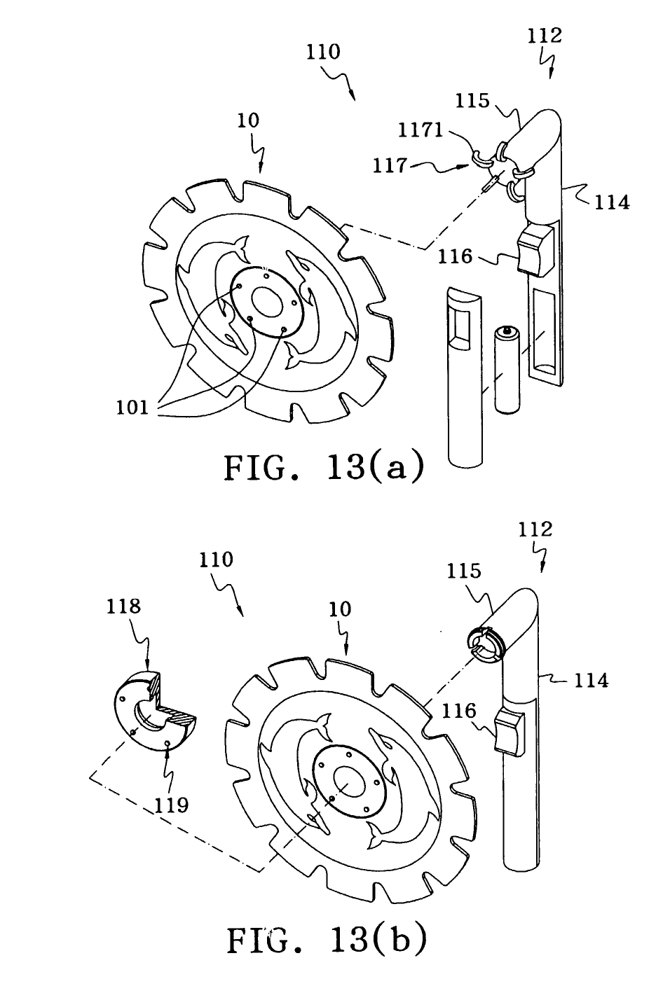

FIGS. 13(a) and 13(b) are exploded diagrams of a fifth embodiment of a portable apparatus of the present invention. The portable apparatus 110 comprises a luminous disk 10 and a bracing portion 112, and the bracing portion 112 further comprises a stretching part 114, a bracing part 115, and a contact part 117. The stretching part 114 has a detachable case for housing at least one battery to be the power supply of the portable apparatus 110, a switch 116 is also provided thereon. The bracing part 115 extending horizontally from the stretching part 114 is able to pass through the central hole of the luminous disk 10 for fixing the bracing portion 112 and the luminous disk 10 together to be the portable apparatus 110 of the present invention. In FIG. 13(a), the contact part 117 is placed on the horizontal end of the bracing part 115 and acts as a talon 1171 having metallic feet positioned corresponding to the conductive terminals on the luminous disk 10. The function of which is to conduct power to the plurality of conductive terminals. The feet of the talon 1171 are elastic, so the feet of the talon 1171 can contract inwardly when being squeezed for passing through the central whole of the luminous disk 10, and then recover to the original state; if the positions of the feet are correct, they are directly in contact with the conductive terminals 101 of the luminous disk 10 and able to conduct electricity.

Moreover, the formation of the contact portion can also be the one as shown in FIG. 13(b), a collar 118 that can be separated from the bracing part 115; one side of the collar 118 has a plurality of contact part 119 corresponded to the amount of the conductive terminals of the luminous disk 10, and on the center of the same side is provided with an indentation thereon with the same diameter as the bracing part 115. After the bracing part 115 passes through the central hole of the luminous disk 10, the collar 118 and the bracing part 115 can be assembled together by pushing tenons of the collar 118 into the indentation the bracing part 115.

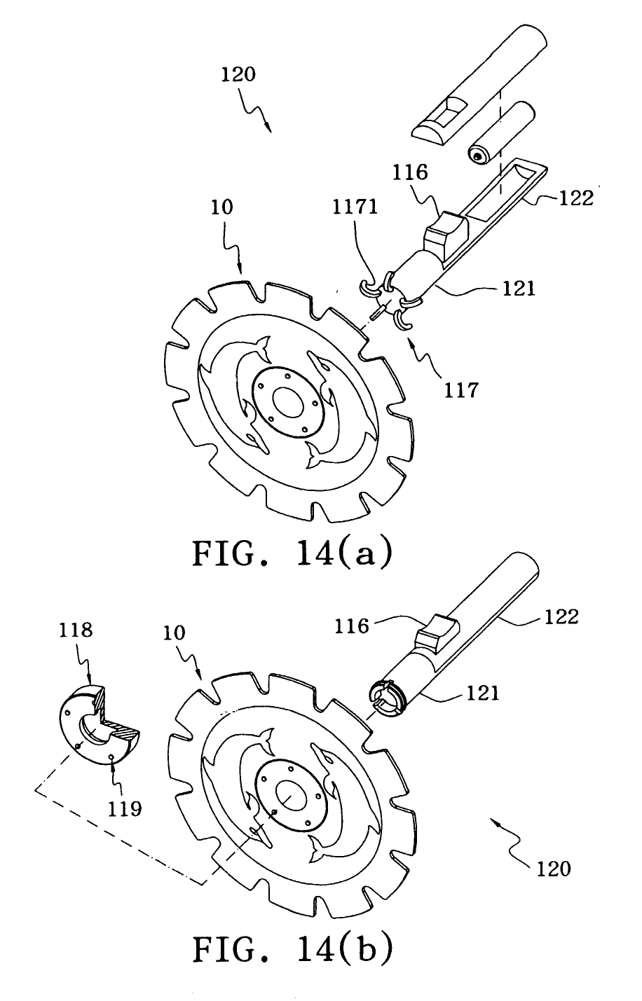

FIGS. 14(a) and 14(b) are exploded diagrams of a sixth embodiment of a portable apparatus of the present invention. The bracing portion 121 and the stretching portion 122 of the portable apparatus 120 of the present embodiment are made coaxial, that means the bracing portion 122 extends coaxially from the bracing portion 121. The design makes the whole device smaller and thus more convenient for user to carry.

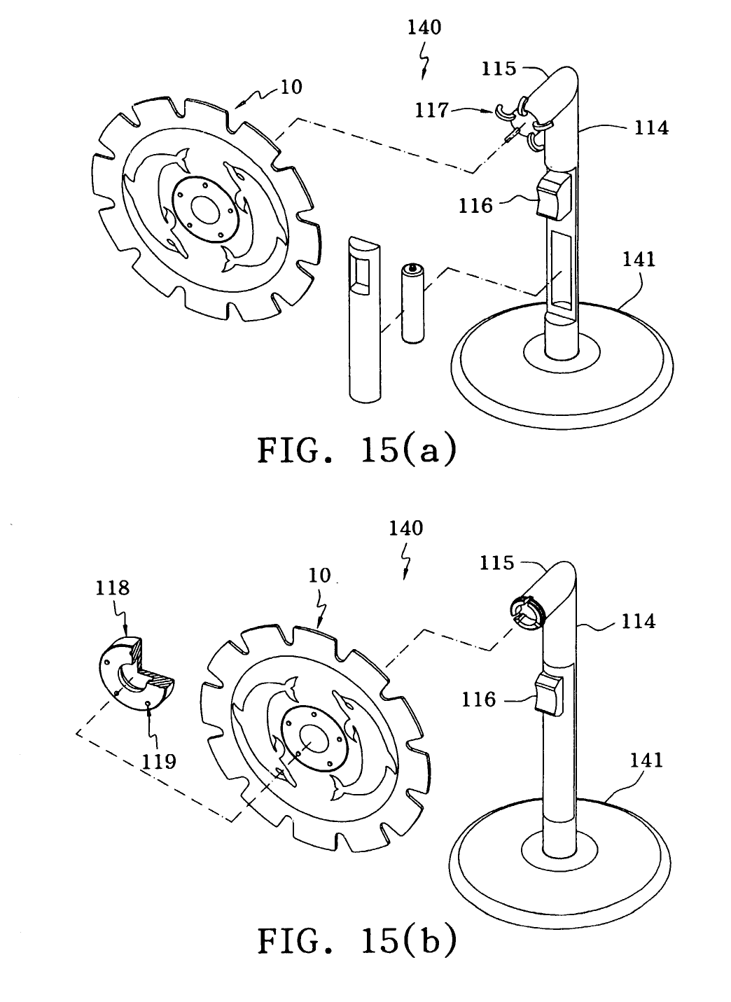

FIGS. 15(a) and 15(b) are exploded diagrams of a seventh embodiment of a portable apparatus of the present invention. The portable apparatus 140 of the present embodiment has a detachable base frame 141 on the bottom end of the stretching portion 114, thus the device can be either held by hand or put on a table. When there is no need to hold the device by a hand, user can attach the base frame so that the whole apparatus can be an upright ornament.

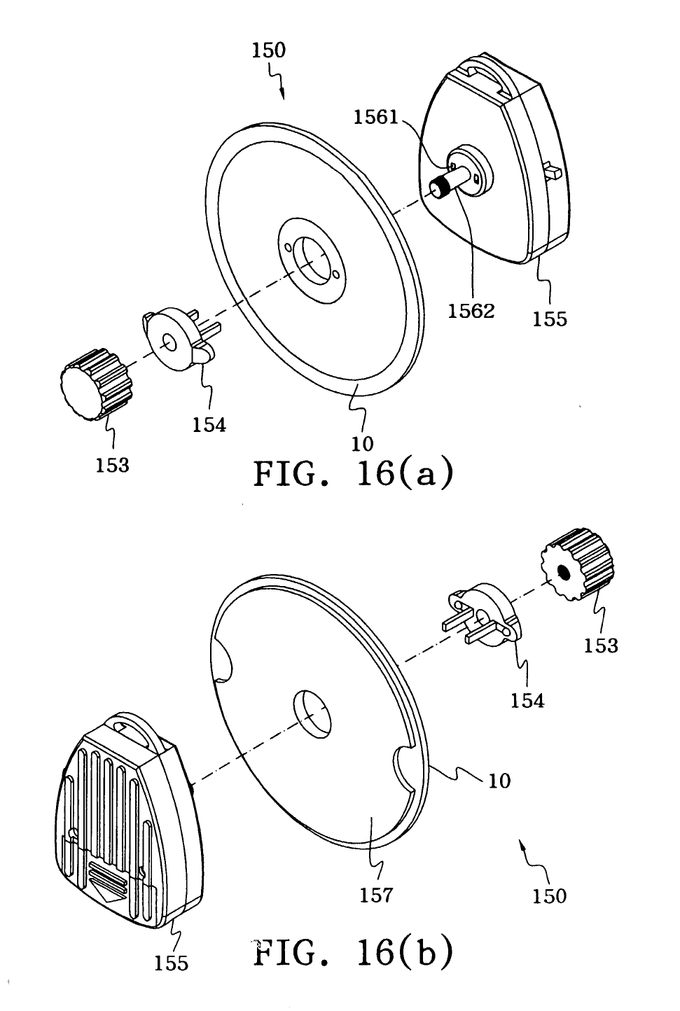

FIGS. 16(a) and 16(b) are exploded diagrams of an eighth embodiment of a portable apparatus of the present invention. The portable apparatus 150 of the present embodiment comprises a luminous disk 10, a rear board 157, a nut 153, a contact part 154, and a bracing portion 155. The bracing portion 155 can house at least one battery as a power supply. As shown in FIGS. 16(a) and 16(b), the side of the bracing portion 155 that faces toward the luminous disk 10 has bumps 1561 and a screw bolt 1562 extended from the center of the bumps 1561. The contact part 154 is in a circular shape, two flanges on the rim of the contact part 154 are provided coplanar thereon, and there are also two columns vertically stretched out from the contact part 154, the positions of the two columns correspond to the two conductive bumps 1561; two L-shaped sheet metals extended from the columns to the flanges are just right to contact the conductive terminals after fabricate, and thus can electrically connect the conductive terminals of the luminous disk 10 to the power supply. The nut 153 can be screwed to the screw bolt 1562 of the bracing portion 155 for fixing every part of the portable apparatus 150 together and completing the fabrication procedure. The rear board 157 displaced between the bracing portion 155 and the luminous disk 10 has similar size with the luminous disk; its function is to prevent the disk lamination from contacting with the bracing portion 155 and thus causes damage. Moreover, a switch is set on one side of the bracing portion 155; an aperture is further set on the top of the bracing portion 155 for user to pass a string through it so as to turn the portable apparatus 150 into a necklace.

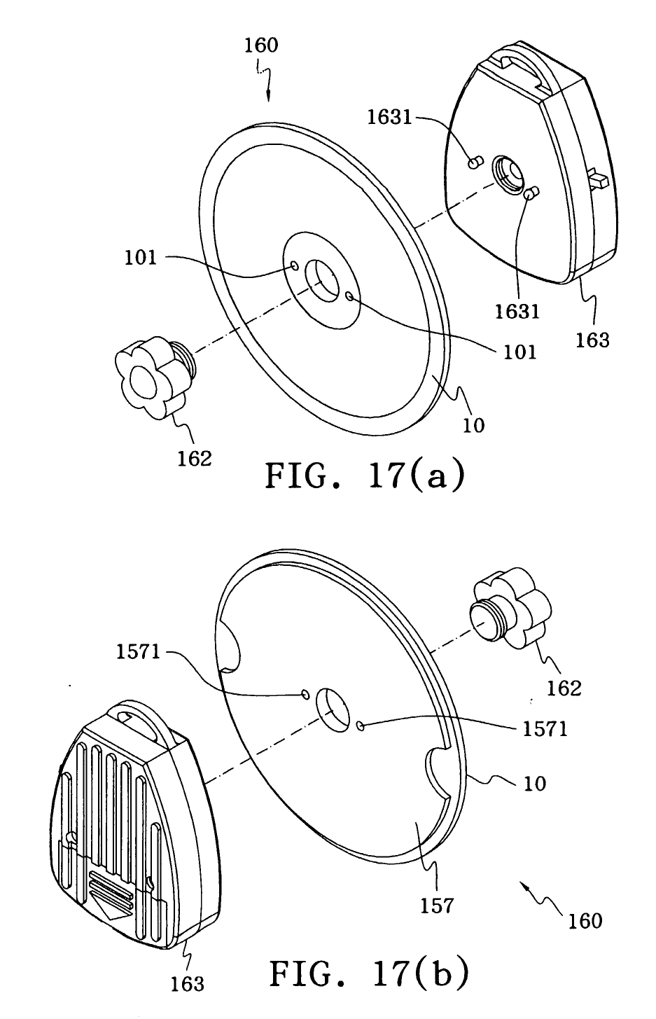

FIGS. 17(a) and 17(b) are exploded diagrams of a seventh embodiment of a portable apparatus of the present invention. The device 160 of the present embodiment comprises a luminous disk 10, a rear board 157, a contact part 162, and a bracing portion 163. As shown in these Figs, the bracing portion 163 has two metal bumps 1631 and two corresponding holes 101 having thread on the side that faces the luminous disk 10. On the internal surface of the holes 101 are further provided with touching switches (figure not shown). The positions of the two bumps 101 correspond to the two conductive holes 101 on the luminous disk 10; they can conduct electricity to the conductive holes 101. There are also two apertures 1571 on the rear board 157 for passing through the two bumps 101 on the bracing portion 163. When the contact part 162 passes through the coaxial central holes of the luminous disk 10 and of the rear board 157 and is fastened to the bracing portion 163, the touching switch will be conducted so as to illuminate for the luminous disk 10.

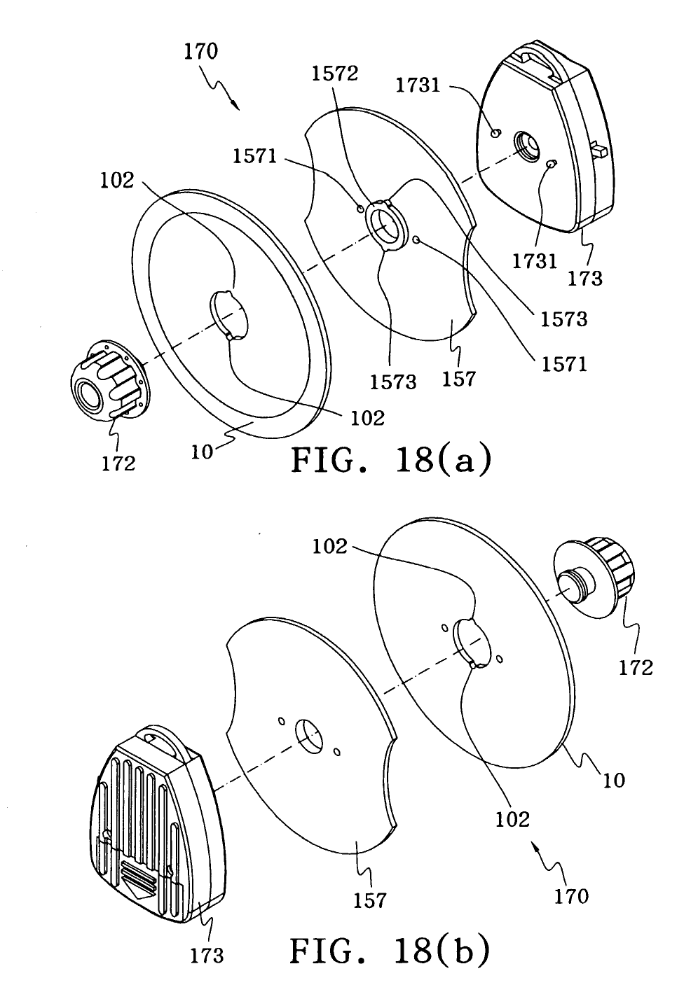

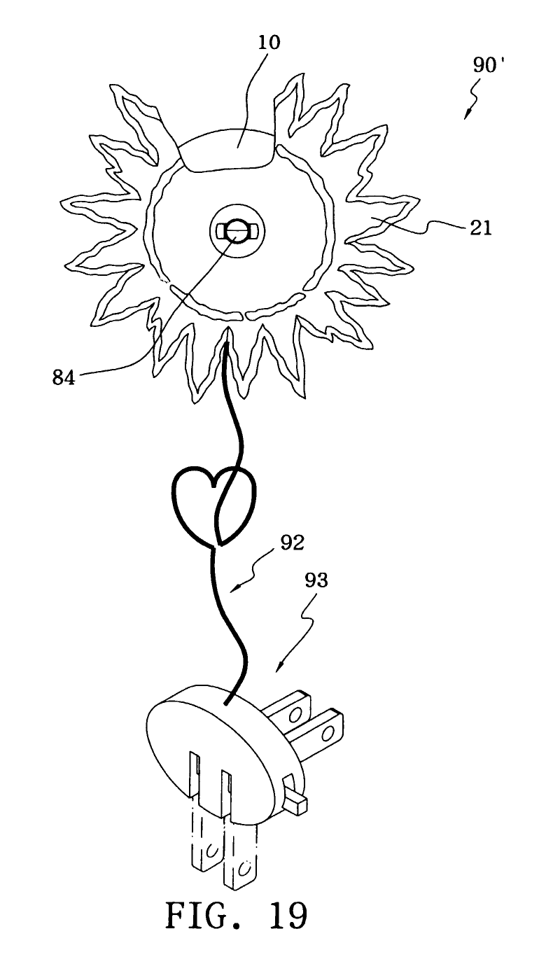

FIGS. 18(a) and 18(b) are exploded diagrams of an eighth embodiment of a portable apparatus of the present invention. The device 170 of the present embodiment comprises a luminous disk 10, a rear board 157, a contact part 172, and a bracing portion 173 as well. The difference between the present embodiment and the seventh embodiment lies in that the rear board 157 of the present embodiment has not only two apertures 1571 for passing through the bumps 1731 on the bracing portion 173, but also a circular fringe 1572 around the central hole, on the edge of the circular fringe 1572 is further provided with two positioning convexes 1573 as shown in FIG. 18(a). The luminous disk 10 also has two aligning concaves 102 on the central hole for passing through the locators of the rear board 157. Such design makes it easier for users to correctly fit the conductive terminals on the luminous disk 10 and the bumps 1571 on the bracing portion 173 during fabrication, making them electrically connected. At last, the contact portion 172 passes through the central holes of the luminous disk 10 and of the rear board 157 and screws to the screw hole of the bracing portion 173; the whole assembly of the portable apparatus 170 is then completed.

Despite the aforementioned structures of the portable apparatus of the present invention, there are still many variations. For example, the appearance of the portable apparatus 90′ of the present invention can be decorated with sticker sheet 21 in various shapes such as heart shape, star shape, flower shape, or other irregular shapes, as shown in FIG. 19. The electro-luminescence (EL) section of the light emitting lamination can be made of any self-luminescence material, such as EL, OLED (organic light emitting diode), or PLED (polymer light emitting diode). The conductive terminals of the luminous disk can be placed not only on the clamping area around the central hole, but also around the outer circle; moreover, the conductive terminals can be connected with the light emitting lamination by a mechanism instead being formed directly on the light emitting lamination. The sticker sheet 21 for user to design and make personal patterns can be made of any material that is light-transmission with one sticky side; there is no need to have any pre-cut shape on it for giving user more freedom to use. Moreover, the bracing portion can be equipped with a touch switch, a shake switch, an on/off flash or a multi-channel flash, the stretching portion can be made as having light-emitting function, writing function, or even filled with candies, thus providing additional values for the product.

The technical contents and features of the present invention are disclosed above. However, anyone that is familiar with the technique could possibly make modify or change the details in accordance with the present invention without departing from the technologic ideas and spirit of the invention. The protection scope of the present invention shall not be limited to what the embodiment discloses, but should include various modification and changes that are made without departing from the technologic ideas and spirit of the present invention, and should be covered by the claims mentioned below.

What is claimed is:

1. A portable apparatus employing a luminous disk, comprising:
a luminous disk; and
a bracing portion including:
(a) a bracing part; and
(b) a contact part connected to said bracing part, said contact part used for conducting electricity to said luminous disk and combining said bracing part and said luminous disk together.

2. The portable apparatus according to claim 1, wherein said bracing portion further includes a stretching part connected to said bracing part.

3. The portable apparatus according to claim 2, wherein said stretching part has a detachable base frame.

4. The portable apparatus according to claim 1, wherein a feature of said contact part is like a talon or a collar.

5. The portable apparatus according to claim 1, wherein there are apertures for passing through a string on the top of said bracing portion.

6. The portable apparatus according to claim 1, wherein said bracing portion further includes a shake switch, an on/off flash or a multi-channel flash.

7. The portable apparatus according to claim 1, wherein said bracing portion further includes a rear board disposed between said luminous disk and said bracing portion for preventing said disk lamination from contacting with said bracing part.

8. The portable apparatus according to claim 1, wherein one surface of said luminous disk is adhered by a light-transmission sticker exhibiting patterns designed by users.

9. The portable apparatus according to claim 10, wherein said light-transmission sticker is designed by a personal computer and printed by a picture output device.

10. The portable apparatus according to claim 1, wherein said luminous disk can illuminate partially, intermittently or with different colors.

11. The portable apparatus according to claim 1, wherein said bracing part further comprises:
a shapable mechanism connected to said contact part; and
a plug connected to said shapable mechanism.

12. The portable apparatus according to claim 11, wherein a configuration of said plug is suitable to a car.

13. The portable apparatus according to claim 1, wherein said luminous disk comprises:
a disk lamination including a substrate and a metallic reflecting layer overlaid on a surface of said substrate; and
a light emitting lamination superposed on the surface of said metallic reflecting layer opposite to said substrate, including:
(a) an electroluminescence section for luminescing when an external electrical power is supplied; and
(b) a biasing section for conducting said external electrical power onto said electroluminescence section.

14. The portable apparatus according to claim 13, wherein said disk lamination further includes a dye layer superposed between said flat substrate and said metallic reflecting layer for forming a pattern representing encoded digital data under illumination of a laser beam.

15. The portable apparatus according to claim 13, wherein said biasing section further includes a distributing layer formed between said electroluminescence section and said metallic reflecting layer.

16. The portable apparatus according to claim 13, wherein said electroluminescence section includes a fluorescent layer made of an OLED, EL or PLED.

17. The portable apparatus according to claim 13, wherein said biasing section further comprises a first and a second conductive terminal for conducting with said external electrical power.

18. The portable apparatus according to claim 13, wherein said disk lamination comprises conductive terminals electrically connected to said biasing section by through holes for directly receiving said external electrical power.

19. The portable apparatus according to claim 13, wherein a central hole of said luminous disk comprises a plurality of aligning concaves.

20. A portable apparatus employing a luminous disk, comprising:
a luminous disk; and
a bracing portion including:
(a) a bracing part having a shapable mechanism and a plug connected to said shapable mechanism; and
(b) a contact part connected to said shapable mechanism, said contact part used for conducting electricity to said luminous disk and combining said bracing part and said luminous disk together.

21. The portable apparatus according to claim 20, wherein said bracing portion further includes a stretching part connected to said bracing part.

22. The portable apparatus according to claim 21, wherein said stretching part has a detachable base frame.

23. The portable apparatus according to claim 20, wherein a feature of said contact part is like a talon or a collar.

24. The portable apparatus according to claim 20, wherein a plurality of apertures are formed for passing through a string on the top of said bracing portion.

25. The portable apparatus according to claim 20, wherein said bracing portion further includes a shake switch, an on/off flash or a multi-channel flash.

26. The portable apparatus according to claim 20, wherein said bracing portion further includes a rear board disposed between said luminous disk and said bracing portion for preventing said disk lamination from contacting with said bracing part.

27. The portable apparatus according to claim 20, wherein one surface of said luminous disk is adhered by a light-transmission sticker exhibiting patterns designed by users.

28. The portable apparatus according to claim 20, wherein said luminous disk comprises:
a disk lamination including a substrate and a metallic reflecting layer overlaid on a surface of said substrate; and
a light emitting lamination superposed on the surface of said metallic reflecting layer opposite to said substrate, including:
(a) an electroluminescence section for luminescing when an external electrical power is supplied; and
(b) a biasing section for conducting said external electrical power onto said electroluminescence section.

29. The portable apparatus according to claim 28, wherein said electroluminescence section includes a fluorescent layer made of an OLED, EL or PLED.
